(19) United States
(12) Patent Application Publication
(10) Pub. No.: US 2012/0284194 A1
(43) Pub. Date: Nov. 8, 2012

(54) SECURE CARD-BASED TRANSACTIONS USING MOBILE PHONES OR OTHER MOBILE DEVICES

(75) Inventors: Jie Liu, Medina, WA (US); Nissanka Arachchige Bodhi Priyantha, Redmond, WA (US); Aman Kansal, Issaquah, WA (US); Suman Nath, Redmond, WA (US); Dimitrios Lymperopoulos, Bellevue, WA (US); Michel Goraczko, Seattle, WA (US)

(73) Assignee: MICROSOFT CORPORATION, Redmond, WA (US)

(21) Appl. No.: 13/099,913

(22) Filed: May 3, 2011

(51) Int. Cl. G06Q 40/00; H04L 9/28

(52) U.S. Cl. 705/66

(57) ABSTRACT

A “Portable Card Generator” is implemented within a portable device, such as a mobile phone, and provides various techniques for writing secure account information from user selected accounts to a “wildcard” having rewritable magnetic stripes, rewritable RFID tags, and/or rewritable smartcard circuitry. The account information is retrieved by the portable device from local or remote stores of user accounts. Once that account information is written, the wildcard is then available for immediate use for credit card or debit-type payments, loyalty card use, etc. Consequently, by providing a credit card sized object having a rewriteable magnetic stripe, RFID tag, and/or smartcard circuitry, in combination with account information for various credit cards, debit cards, consumer loyalty cards, insurance cards, ID cards or badges, etc., the user is no longer required to physically carry those cards in order to use the corresponding accounts within existing card-based infrastructures.

### BACKGROUND

1. Technical Field

A “Portable Card Generator” uses a portable device, such as a mobile phone, to write secure account information from user selected accounts to a “wildcard” having rewritable magnetic stripes, rewritable RFID tags, and/or rewritable smartcard circuitry, with that wildcard then being available for immediate use for credit card or debit-type payments, loyalty card use, etc.

2. Background Art

Consumers generally carry many cards having magnetic stripes which contain account information. Examples of such cards include credit cards, debit cards, loyalty cards (e.g., grocery store member cards, book store member cards, frequent flyer cards, etc.), insurance cards, blood donor cards, etc. Each of these cards is generally the same shape and size, and includes a magnetic stripe that encodes unencrypted account information corresponding to the particular card. These magnetic stripes are readable with existing card reader infrastructures throughout the world, including, ATMs, gas pumps, store payment points (e.g., card readers), etc. Unfortunately, the sheer number of cards carried by the typical consumer can quickly become burdensome.

Various schemes to reduce the consumers need to carry various credit or payment cards include the concept of “mobile payments” or “mobile wallets”. Such concepts provide an alternative payment method to the use of cash, checks, or credit cards. In general, such schemes allow a consumer to use a mobile phone to pay for a wide range of services and digital or hard goods. Typical models for these types of mobile payments include premium SMS based transactional payments, direct mobile billing, mobile web payments using Wireless Application Protocols (WAP), and contactless NFC (Near Field Communication), among other similar techniques.

For example, in the case of premium SMS based transactional payments, the consumer uses her mobile phone to send a payment request via an SMS text message to their bank or credit issuer, and a premium charge is applied to their phone bill or their online wallet. The merchant involved is then informed of the payment success and can then release the paid for goods. Since a trusted delivery address has typically not been given, goods purchased using such techniques are most frequently digital content (e.g., books, music, video, ringtones, wallpapers, etc.) with the merchant replying using a Multimedia Messaging Service (MMS) to deliver the purchased content. These MMS techniques also sometimes deliver barcodes back to the consumer's mobile phone, which is then displayed on the screen for scanning to provide confirmation of payment to the merchant. Such techniques can also be used to generate “electronic tickets” for access to cinemas and events or to collect hard goods.

Unfortunately, these types of SMS transactions are dependent upon having a good carrier signal that allows the phone to send and receive SMS messages. Further, such transactions also are considered to have poor reliability, since transactional payments will fail whenever messages get lost. Another problem associated with these types of SMS-based transactions is that sending messages can be slow and it can take hours for a merchant to get receipt of payment. Clearly, consumers do not want to be kept waiting more than a few seconds. Security is also a problem with SMS-type payment models, since any encryption ends in the radio interface, with the resulting message being sent in plaintext. In addition, instead of being compatible with existing infrastructures, there are many high costs associated with this method of payment, including the cost of setting up short codes and paying for the delivery of media via MMS, and the resulting customer support costs to account for the number of messages that get lost or are delayed.

As noted above, direct mobile billing is another option that allows the consumer to use her mobile phone to provide a mobile billing option during checkout at an e-commerce site to make a payment. In general, such techniques use a two-factor authentication involving a PIN and One-Time-Password after which the consumer's mobile account is charged for the purchase. This alternative payment method does not require the use of credit/debit cards or pre-registration at an online payment solution such as PayPal®, thus bypassing banks and credit card companies altogether. Again, problems with such schemes include the fact that they are generally used to purchase digital content rather than hard goods, and that these types of schemes are not compatible with existing card-based payment infrastructures that are ubiquitous throughout the world.

Mobile web payments (using WAP) generally allow a broader range of purchase options for the consumer since any retailer with an online presence that accepts user payments can generally operate with these types of payment schemes. In particular, just as if the consumer was shopping online from a home computer, web pages displayed on the user's phone or other web-enabled mobile device allows the consumer to use web pages displayed or additional applications downloaded and installed on the device to make a payment via WAP. However, unless the consumer's mobile account is directly charged through a mobile network operator, the use of a credit/debit card or pre-registration at an online payment solution such as PayPal® is still required just as in a desktop environment.

As can be seen from the above examples, these types of techniques, and related techniques such as direct operator billing, using mobile web access to enter credit card information into a payment site or portal. Similarly, online wallets or payment systems (e.g., PayPal®, Amazon Payments™ and Google Checkout™, etc.) typically require the user to register for an account, enter her credit card number and other information such as her mobile phone number. The provider then sends the user an SMS with a PIN. The user then enters the received PIN, thereby authenticating the number. For subsequent payments, the user then simply uses the online payment system by re-entering her PIN to authenticate payment for a particular online payment.

In contrast, contactless near field communication (NFC) (e.g., Bluetooth, RFID, etc.) based systems are often used to pay for purchases made in physical stores or transportation services. For example, a consumer generally uses a special mobile phone equipped with a smartcard or the like by waving her phone near a reader module which receives the account information from the device via NFC communications protocols. Most transactions do not require authentication, but some require authentication using PIN, before transaction is completed. Such payments are generally deducted from pre-paid account, charged to a credit card, charged to mobile phone account, or charged to a bank account directly. Unfortunately, these types of mobile payment schemes face significant challenges for wide adoption due to the lack of supporting infrastructure and common standards.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of prior technologies may be noted or discussed herein, the claimed subject matter is not intended to be limited to implementations that may solve or address any or all of the disadvantages of those prior technologies.

A “Portable Card Generator”, as described herein, is implemented within a portable device, such as a mobile phone, and provides various techniques for writing secure account information from a user selected account to a rewritable magnetic stripe that is either accessible to or coupled to that portable device. The account information written to the magnetic stripe is retrieved from a local or remote store of user accounts that is accessible to the portable device. Once that account information is written, the magnetic stripe is then available for immediate use for credit card or debit-type payments, loyalty card use, etc. Further, in addition to magnetic stripe based cards, in various embodiments, the Portable Card Generator includes the capability to write to RFID tags and/or smartcard circuitry to create cards for accounts using either RFID or smartcard based hardware and protocols. In general, operation of the Portable Card Generator for these types of cards is similar to the techniques used with respect to magnetic stripe based cards.

In other words, the Portable Card Generator allows the user to carry a single object (referred to herein a “wildcard”) having a rewriteable magnetic stripe (and/or RFID and smartcard circuitry) that is easily and quickly encoded with any of the user's accounts via a writer device integrated into or coupled to the user's mobile phone or other mobile device. Note that this account information is referred to herein as a “wildcard object file.” In various embodiments, the wildcard can include any combination of rewritable magnetic stripes, rewritable RFID tags, and rewritable smartcard circuitry. Thus, regardless of the underlying card technology, the encoded card is then used as if it were the original card corresponding to the selected user account. In other words, the programmed wildcard is useable within existing card-based infrastructures as a surrogate for the original card account corresponding to the selected wildcard object file.

Consequently, by providing access to the account information for multiple cards, such as, for example, credit cards, debit cards, consumer loyalty cards (e.g., grocery store member cards, book store member cards, frequent flyer cards, etc.), insurance cards, blood donor cards, ID cards or badges, etc., the user is no longer required to physically carry any of those cards in order to use such cards within existing card-based infrastructures. In general, the rewritable wildcard is approximately the same size and shape as a typical credit card or the like so as to be fully compatible with existing card-based infrastructures.

In various embodiments, the Portable Card Generator provides a variety of techniques for storing and accessing user account information, writing selected account information to the rewritable card, and ensuring that user account information is not used or accessible by unauthorized persons. More specifically, the Portable Card Generator provides security for users who use mobile phones or other mobile devices to manage their payment cards, bank cards, credit cards, loyalty cards, etc.

In various embodiments, the security provided by the Portable Card Generator ensures that only authorized users can access and use authorized cards on a particular mobile device. In various embodiments, the security provided by the Portable Card Generator also ensures that a user's authorized card cannot be used by anyone else. Further, in various embodiments, the security provided by the Portable Card Generator also ensures that users can manage the cards (e.g. cancel or suspend them) in the event that the portable device (e.g., mobile phone) is lost or stolen. Finally, for added security, in various embodiments, users can request one-time use card numbers on the fly from their card issuer for purposes of added security. These one-time numbers are then written as described above and used as with any other card, after which that number expires and can no longer be used.

In view of the above summary, it is clear that the Portable Card Generator described herein provides various unique techniques for retrieving user account information from a database of one or more user accounts that is then written to a wildcard for use in existing card-based infrastructures, including magnetic stripe, RFID, and smartcard based infrastructures. Note that once the account information is written to the wildcard, that wildcard is referred to herein as a “programmed wildcard.” In addition to the just described benefits, other advantages of the Portable Card Generator will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for implementing various embodiments of a Portable Card Generator, as described herein.

FIG. 2 illustrates the use of a “writing module” coupled to a user portable device such as a cell phone, a media player, or a dedicated portable device to program “wildcards” for implementing various embodiments of the Portable Card Generator, as described herein.

FIG. 3 is a general system diagram depicting a simplified general-purpose computing device having simplified computing and I/O capabilities for use in implementing various embodiments of the Portable Card Generator, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

### 1.0 Introduction

In general, a “Portable Card Generator”, as described herein, is implemented within a portable device, such as a mobile phone, and provides various techniques for writing secure account information (also referred to herein as a “wildcard object file”) from user selected accounts to a “wildcard” having any combination of rewritable magnetic stripes, rewritable RFID tags, and/or rewritable smartcard circuitry. The account information is retrieved by the portable device from local or remote stores of user accounts. Once that account information is written, the wildcard is then available for immediate use for credit card or debit-type payments, loyalty card use, etc. In other words, the programmed wildcard is useable within existing card-based infrastructures as a surrogate for the original card account corresponding to the selected wildcard object file.

Consequently, by providing a credit card sized object having a programmable/rewriteable magnetic stripe, RFID tag, and/or smartcard circuitry, in combination with account information for various credit cards, debit cards, consumer loyalty cards, insurance cards, ID cards or badges, etc., the user is no longer required to physically carry those cards in order to use the corresponding accounts within existing card-based infrastructures. In general, the rewritable wildcard is approximately the same size and shape as a typical credit card or the like so as to be fully compatible with existing card-based infrastructures. However, size and shape may vary, depending upon the technology being used (i.e., magnetic stripe, RFID, smartcard).

Note that for purposes of explanation, the mobile device used to write account information to the wildcard will generally be discussed in the context of a mobile phone or the like having an integral or attached writing module or device. Further, it should be understood that the techniques described herein can be adapted to any portable or mobile device, including, but not limited to mobile phones, media players, tablet type devices, hand-held computing devices, etc. However, such technology can also be implemented within a home-based or non-portable system that allows the user to program or write one or more wildcards before leaving home. However, it is generally expected that it will be more useful to allow the user to write account information to wildcards on the fly, using a writing module integrated into or coupled to whatever portable device they are carrying.

More specifically, the Portable Card Generator stores multiple cards' information in the user's phone. Such cards include, but are not limited to, credit cards, ATM cards, loyalty cards, frequent flyer cards, membership cards, coupons, etc., having a magnetic stripe or barcode, or in various embodiments, RFID tags, or smartcard circuitry. Information that may be included on the card includes credit card number, user name, card logo, front and back images of the real card, expiration date, signature, card usage history, card promotional information, user notes, or any other information that the card issuer or user would like to associate with the card. Further, by including conventional image generation technology on one or both faces of the wildcard, the wildcard can also display images relating to the card being written. However, since image display on the wildcard itself can require onboard power, low power imaging technologies are generally used for such embodiments to reduce or eliminate the need for onboard power on the wildcard itself.

Examples of such imaging technologies include, but are not limited to electronic paper, e-paper, electronic ink, etc. These and similar technologies provide a range of display technologies which are designed to mimic the appearance of ordinary ink on paper. Further, unlike conventional backlit flat panel displays, electronic paper type displays reflect light like ordinary paper. Many of these technologies can hold text and images indefinitely without using electricity, while allowing images to be changed later. Flexible electronic paper uses plastic substrates and plastic electronics for the display backplane. Consequently, such techniques are easily adapted for use in constructing various embodiments of the wildcard that allow for the use of images without requiring onboard power. In these cases, power for image changes is provided by the mobile phone or other device at the time that the selected account information (including any corresponding images) is written to the wildcard, though small capacitive devices optionally embedded within the wildcard may be used as a backup power source, if needed, for maintaining images over extended periods.

Regardless of whether the wildcard is implemented with imaging technologies, the general process for using the wildcard remains the same. In particular, at any time prior to using the card at the point of sale (or other card use location or scenario), the user selects which card she wants to use among the cards stored in her mobile phone. The user may also request a one-time use card number from her card issuer, if desired. The account information for that card is then used to create a temporary card (similar to cloning the original card) using the rewritable wildcard by writing the account information to the appropriate media on the wildcard (i.e., magnetic stripe, RFID tag, and/or smartcard circuitry). This information is written to the wildcard through an actuator dongle (also referred to herein as a “card writer” or “writing module”) that is either coupled to the mobile phone or embedded or integrated within the phone.

Once the account information has been written to the wildcard, the user simply swipes or docks the wildcard in the magnetic stripe card reader (or RFID or smart card reader) of the vender, merchant, bank, etc., in the same manner as if the user was presenting an official card issued by the bank or other card issuer for the transaction. The reader will then read the information written by the phone to the wildcard and complete the transaction as if it is a conventional card. Note that no changes to existing card-based infrastructures are required for those infrastructures to be fully compatible with the wildcard described herein. In various embodiments, the user may further receive electronic receipts corresponding to wildcard usage into the phone (or other mobile device) via email, SMS, or any other messaging technology to keep track of payments or other transactions.

Note that the following discussion generally described a variety of techniques for implementing secure storage and writing of account information to the wildcard. Specific examples of the hardware used for such purposes is described in copending patent application Ser. No. TBD, filed on TBD, the subject matter of which is incorporated herein by this reference.

### 1.1 System Overview

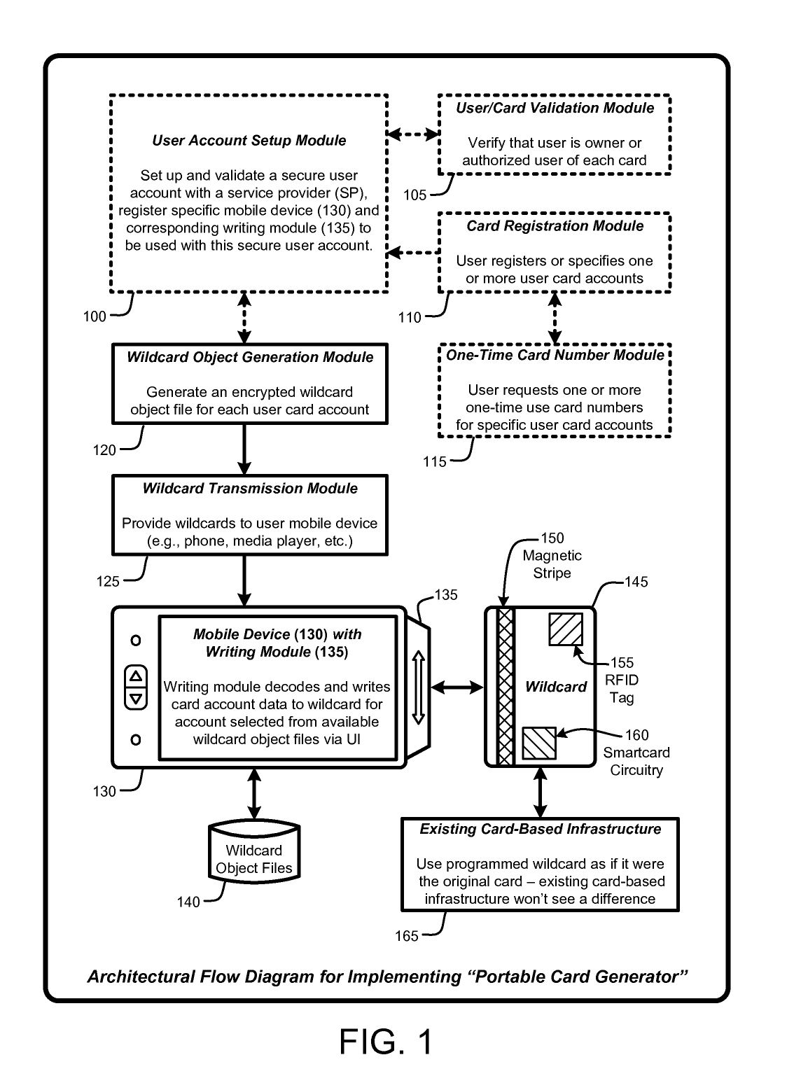

As noted above, the “Portable Card Generator,” provides various techniques for writing secure account information from user selected accounts to a “wildcard” having any combination of rewritable magnetic stripes, rewritable RFID tags, and/or rewritable smartcard circuitry. The processes summarized above are illustrated by the general system diagram of FIG. 1. In particular, the system diagram of FIG. 1 illustrates the interrelationships between program modules for implementing various embodiments of the Portable Card Generator, as described herein. Furthermore, while the system diagram of FIG. 1 illustrates a high-level view of various embodiments of the Portable Card Generator, FIG. 1 is not intended to provide an exhaustive or complete illustration of every possible embodiment of the Portable Card Generator as described throughout this document.

In addition, it should be noted that boxes and interconnections between boxes that may be represented by broken or dashed lines in FIG. 1 represent alternate embodiments of the Portable Card Generator described herein, and that any or all of these alternate embodiments, as described below, may be used in combination with other alternate embodiments that are described throughout this document.

In general, as illustrated by FIG. 1, the processes enabled by the Portable Card Generator begin operation by setting up an optional user account with a service provider (SP). More specifically, a user account setup module 100 is used to set up and validate a secure user account with a service provider (SP), register a specific mobile device (130) for use with that secure user account, and register a corresponding writing module (135) to be used with the secure user account. Note that these processes are described in further detail in Section 2.3 and 2.4.

Once the user account has been set up, a user/card validation module 105 is used to verify that the user is the owner or authorized user of each card that the user registers with the user account via a card registration module 110 (See Section 2.4). In general, the card registration module 110 allows the user to register or specify one or more user card accounts for use with the portable card generator. In addition, a one-time card number module 115 allows the user to request one or more one-time use card numbers for specific user card accounts. See Section 2.6 for a discussion of one-time use card numbers.

In general, it should be noted that there is no requirement to use a secure SP or to register and verify the user and user card accounts with the SP (i.e., elements 100 through 115 of FIG. 1, as discussed above). In fact, in the most generic scenario, wildcards can simply be generated locally using information provided by the user for each user card (or read from each user card via a conventional card reader, not shown). Unfortunately, while such implementations are possible using various embodiments of the Portable Card Generator, a large number of security concerns may arise in the case where some type of trusted third party verification service is not used. Therefore, while the secure user account is not required, nor is it the only possible verification process, the following discussion assumes the use of such secure user accounts for purposes of explanation.

Once the user accounts have been set up and one or more cards registered to the account, as discussed above, a wildcard object generation module 120 is used to generate encrypted wildcard object files (see Section 2.4.4) for each user card account registered with the SP. These wildcard object files 140 are then provided by the SP to the user's mobile device 130 via a wildcard transmission module 125 for local storage on that device.

Next, once the user's mobile device 130 has access to one or more wildcard object files 140, the user is presented with a user interface (UI) on a display screen of the mobile device that allows the user select one of the user card accounts represented by an encrypted wildcard object file. Once the user has selected one of the wildcard object files 140 via the UI, a wildcard 145 is temporarily coupled to, inserted into, or swiped through the writing module 135 associated with the mobile device. The particular manner in which the wildcard 145 is interfaced with the writing module 135 is dependent upon the particular technology being used by the writing module and the wildcard (e.g., magnetic stripe 150, RFID tag 155, smartcard circuitry 160, etc.). In any case, the general concept here is that the writing module 135 decodes and writes the card account information from the selected wildcard object file 140 to the wildcard 145.

As soon as that information has been written to the wildcard, the wildcard is then available for use with existing card-based infrastructures 165 as if that wildcard were the original user card. In fact, existing card-based infrastructures 165 will not see a difference between the wildcard 145 and the original card. Further, and, advantageously, no modification to the existing card-based infrastructure 165 is necessary in order to ensure full compatibility between the wildcard 145 and the existing card-based infrastructure.

### 2.0 Operational Details of the Portable Card Generator

The above-described program modules are employed for implementing various embodiments of the Portable Card Generator. As summarized above, the Portable Card Generator provides various techniques for writing secure account information from user selected accounts to a “wildcard” having any combination of rewritable magnetic stripes, rewritable RFID tags, and/or rewritable smartcard circuitry. The following sections provide a detailed discussion of the operation of various embodiments of the Portable Card Generator, and of exemplary methods for implementing the program modules described in Section 1 with respect to FIG. 1. In particular, the following sections provide examples and operational details of various embodiments of the Portable Card Generator, including: an overview of security considerations associated with the use of the Portable Card Generator and the associated wildcards; an actuator or “writing module” for local card generation; service or card provider considerations; exemplary implementation scenarios, exemplary security issues and solutions; single use card numbers for enhanced security; and additional embodiments and considerations.

### 2.1 Overview of Security Considerations

In general, to ensure security when writing user account information to a wildcard and using those cards for various purposes, several issues are considered in order to maintain security.

In particular, in various embodiments, the Portable Card Generator provides techniques (discussed in further detail below) for addressing the following security concerns:
a. In various embodiments, security is enhanced by using a secure actuator (i.e., the “writing module”, card writer or emulator) on the phone that is limited to writing authorized contents to the wildcard;
b. Further, in various embodiments, security is enhanced by limiting the Portable Card Generator to be operable with authorized wildcards that are paired to the user's mobile phone (see Section 2.3). In other words, one user will not be able to use their wildcards with another user's mobile phone;
c. In general, a service provider generates authorized contents (i.e., “wildcard object files”) that are transmitted to the user's phone after the user's identity, phone, and any cards managed by that service provider are verified;
d. Users can manage their cards on a secure web site (i.e., a secure user account managed by a service provider), such as by uploading card information to the secure website, deactivating or cancelling one or more cards via that website, editing or updating card information, etc. Any time that card information is changed, an updated wildcard object file is created for that card and provided to the user's phone;
e. The service provider can offer one-time use card numbers that are transmitted to the user's mobile phone (as a wildcard object file) for upload to the wildcard. In general, such numbers become invalid once they have been used by the user (or once a predefined spending limit or time limit has been reached), thereby reducing or eliminating fraudulent use of the user account information.

### 2.2 Actuator or “Writing Module” for Local Wildcard Generation

An actuator (e.g. magnetic stripe writer, RFID writer, smartcard writer, etc.) coupled to or integrated into the phone (or other mobile device) is used to write the user selected account information to the wildcard. As noted above, the actuator is also referred to herein as a “writing module”. In general, account information is stored as an encrypted data file using any desired encryption. The account information is then decrypted by the writing module using a unique or private decryption key (i.e., K_{d}) that works with authorized wildcards. The writing module then writes that decrypted information to the wildcard.

Note that with conventional card-based infrastructures, data written on magnetic stripes of credit cards and the like is not generally encrypted. However, in various embodiments (e.g., ID cards having secure information), the writing module can first decrypt encrypted information in a wildcard object file and then write card information to a wildcard. Again, as noted above, specific examples of the hardware used for such purposes is described in copending patent application Ser. No. TBD, filed on TBD, the subject matter of which is incorporated herein by this reference.

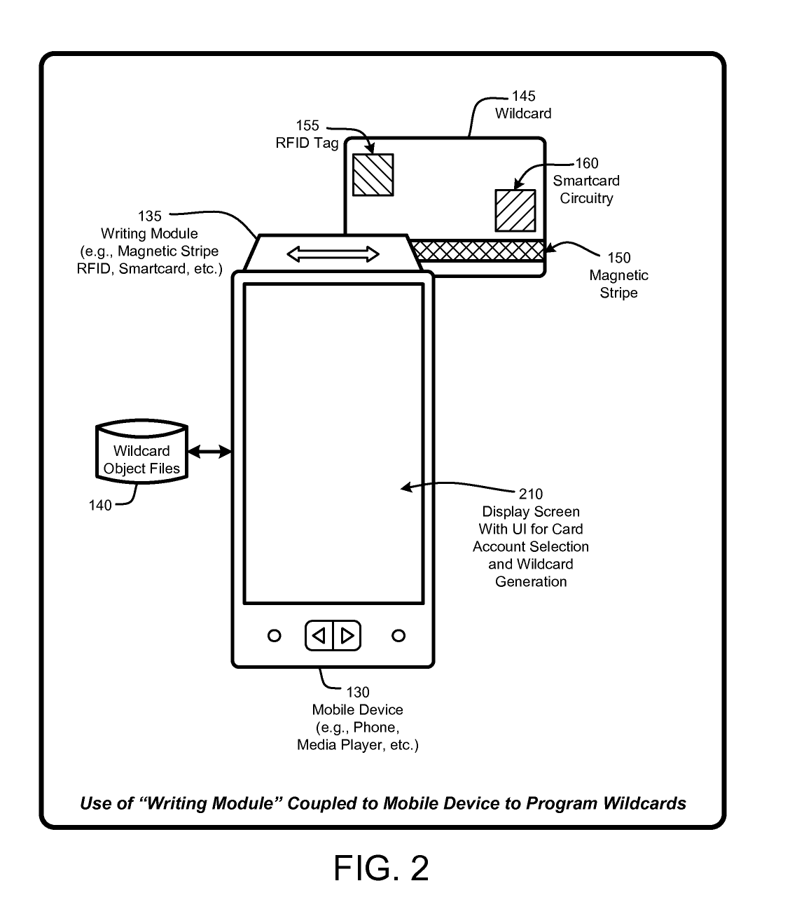

FIG. 2 provides a simple illustration of the use of the writing module 135 coupled to the user's portable device 130 (e.g., phone, media player, tablet computing device, etc.) to program the wildcard 145 for implementing various embodiments of the Portable Card Generator. In particular, in this example, the user simply selects one of the available card accounts via a display screen 210 which provides a UI with which the user can browse and select from the available user card accounts. Once the user has made such a selection, the corresponding wildcard object file 140 is decoded by the writing module 135 as the user interfaces the wildcard 145 with the writing module. As noted above, as soon as the card account information is written to the wildcard 145, that wildcard is available for use within any existing card-based infrastructure.

### 2.3 Service Providers

In the most general case, a conventional card reader device can be used to simply read or extract the contents of a particular card then store that information as one of the user selectable accounts (i.e., a wildcard object file) for use in generating a programmed wildcard. However, such capabilities can cause various security concerns. Consequently, in various embodiments, security is maintained by using a “service provider” as a type of third party trust mechanism to verify the particular phone or other mobile device of the user, user card information, user identity for each card, and optionally, identity of wildcards that are authorized for use with a particular mobile phone via a verified or secure user account maintained or managed by the service provider. Once all of this information is verified, the service provider then transmits or transfers encrypted card account information (i.e., wildcard object files) to the user's mobile phone for each card managed by the service provider. As noted above, this encrypted card account information is then decrypted using a unique key and written to an authorized wildcard when that account is selected by the user.

In general, authorization of particular wildcards for use with a particular mobile device is achieved by associating the owner of the phone with an account at the service provider. For example, one way in which this can be accomplished is at the point of sales of the phone, a service account (such as a Windows® Live ID) is used to activate the mobile phone. The phone can then be linked to the buyer's social security number, credit history, or other secure identification or account information. In various embodiments, a wildcard can only be associated by one mobile device. Therefore, in such embodiments, the service provider encrypts card information with the keys from both the mobile device and card writer to generate wildcard object files.

### 2.4 Exemplary Implementation Scenarios

The following paragraphs generally describe various embodiments for creating a secure user account with a service provider, registration of a particular phone for the user account, secure registration of card account information with the user account, generation of wildcard object files from the account information of each user card account, and secure writing of that account information to a wildcard. Note that the following discussion describes these capabilities in the context of magnetic stripes (e.g., credit cards, debit cards, etc.). However, the extension to other card technologies (e.g., RFID, smartcard circuitry, etc.) should be understood in view of following discussion.

### 2.4.1 Initial Phone Setup for Wildcard Implementation

Initial setup of the user's phone, or other mobile device, is generally performed in a manner that protects card security and ensures that if the phone is lost or stolen, any account information on that phone will remain encrypted. The following discussion provides an example of one way in which card and account security can be maintained. However, it should be appreciated that more or less security measures may be applied to this process to achieve the desired level of security. In other words, the general idea is to provide secure account information to the user phone (in the form of wildcard object files), then write that secure information to an authorized wildcard. Any desired encryption and validation techniques can be adapted for this purpose. Consequently, the following discussion should be understood as simply one example of how these tasks may be accomplished, and not as a limitation on the use of the Portable Card Generator for maintaining security of account information and generating wildcards.

First, the phone, or other mobile device, is equipped with a writing module comprising a magnetic stripe writer or emulator (and, in various embodiments, writing capability for RFID tags and/or smart circuitry). This writing module has the capability to write the content of a regular magnetic stripe onto a reprogrammable media (i.e., the wildcard) that is readable or otherwise detectable by a magnetic stripe reader that is typically seen at the point of sales (i.e., existing card-based infrastructure).

The writing module has a unique or private decryption key K_{d}, with a corresponding encryption key Kₑ known to the service provider (referred to as “SP” hereafter). Therefore, to activate a particular mobile phone for card reprogramming capability (i.e., wildcard writing capability), the user (referred to as “Alice” hereafter) registers her phone with a verified user account maintained or managed by the SP. During this phone registration process, the decryption key K_{d} of the writing module associated with the phone is provided to the SP. The SP then validates with the phone carrier (e.g., ATT, Verizon, T-Mobile, etc.) that Alice is the owner or authorized user of the phone. For security purposes, once the phone is registered, it is useful to ensure that the user enables a key lock or similar protection on the phone, though such protection, while recommended, is not required.

### 2.4.2 User Verification with Service Provider

Once the phone setup has been completed such that the phone is now authorized by the SP, Alice will register one or more cards with her verified user account maintained or managed by the SP. One example of a possible secure scenario for setting up such accounts is described below, however, it should be understood that a variety of techniques can be used for this purpose, and that the Portable Card Generator is not intended to be limited by the following example.

In particular, one exemplary process for setting up account information with the SP involves the following steps:
a. Alice logs in to a secure website provided by SP using a private or secret credential that is known to Alice (similar to what she would do with a typical online banking or credit card account). For example, Alice may use an SP provided personal identification number (PIN), her social security number (SSN), or other information known to Alice that the SP can use to verify that Alice is who she claims to be. Such account verification techniques are well known and will not be described in detail herein.
b. Once Alice has logged into her account on the secure website provided by the SP (referred to hereafter as an “SP account”), she then links at least one financial account (e.g., credit card, debit card, bank account, PayPal®, etc.) to her SP account. This financial account is referred to as “FA” hereafter.
c. The SP then contacts the institution maintaining the FA and validates that Alice owns, or is authorized to use, the FA. One simple technique that can be used in the case of a bank account, credit card, or debit card is by having the SP make a small random transaction to the FA, e.g. deposit a small amount of money. Alice will then check the FA and confirm the transaction amount to the SP by accessing the FA to verify that she has access and is thus authorized to use the FA.

Clearly, other verification techniques may also be used by the Portable Card Generator for this purpose, and the above example is intended to provide one example of a wide variety of verification techniques. In any case, once Alice and her phone have been “verified” by the SP, Alice's SP account is then made available for card registration, as discussed below.

### 2.4.3 Card Registration with SP Account

In general, once Alice has set up her verified SP account, the next step is to register one or more credit cards, debit cards, consumer loyalty cards (e.g., grocery store member cards, book store member cards, frequent flyer cards, etc.), insurance cards, blood donor cards, ID cards or badges, etc., with that verified SP account. One example of a possible secure scenario for registering such cards with the SP account is described below, however, it should be understood that a variety of techniques can be used for this purpose, and that the Portable Card Generator is not intended to be limited by the following example.

In particular, one exemplary process for registering cards with the verified SP account involves the following steps:
a. Alice creates an entry in her SP account for any card (referred to as a “CC” hereafter) with card number, card type (VISA, Master, AMEX, bank etc.), and any other necessary or optional information, such as, for example, CC issuer phone number, images associated with the CC, etc.
b. SP then validates that Alice owns, or is authorized to use, the CC by either making a small transaction from the FA onto the card's account (followed by verification of the amount by Alice, as discussed above), or checking with a credit reporting service (e.g., Equifax, Experian, Trans Union, etc.) to ensure that Alice owns, or is authorized to use, the CC being registered.
c. Once the SP is satisfied that Alice is a legitimate or authorized user of the CC, the SP then directly contacts the card issuer and obtains the full account information for the CC from the card issuer that will eventually be used to generate the corresponding wildcard object file for use in writing the account information to the wildcard.
d. Credit cards and ATM cards follow international standards in their card number lengths and prefixes. For other cards, with lesser security requirements, unencrypted object files may be sufficient. Therefore, in various embodiments, the wildcard writing module may examine a particular wildcard object file and reject the numbers (or other account information) if the file represents a credit card or ATM card formation but is not encrypted. This procedure is useful for avoiding the use of an unauthorized wildcard to create a card number on a wildcard that does not belong to the user. In the case of loyalty cards and the like, the SP checks that the content does not match any credit card format. Otherwise, the SP contacts the card issuer to validate the format.

Note also that the user can log into the SP account and cancel, de-active or unregister one or more of her cards at any time. The SP will then immediately report this cancellation, deactivation or de-registration to the card issuer. Cancelled, deactivated or unregistered cards will then be rejected by the bank or credit issuers from then on. This capability helps to protect account information in the event that any original card, a programmed wildcard, or the phone itself is either lost or stolen.

### 2.4.4 Wildcard Object File Generation

Once the user (e.g., Alice), has registered one or more cards with the SP, the SP then generates an encrypted “wildcard object file” for each card. As noted above, when the user registers her phone with the SP, the decryption key, K_{d}, associated with Alice's phone (and more specifically with the writing module coupled to or integrated into her phone) is provided to the SP. The SP then uses K_{d} to create a corresponding encryption key Kₑ. The SP then uses the encryption key Kₑ to encode the account information for each registered CC, thereby generating a wildcard object file for each registered CC. One example of a possible secure scenario for generating wildcard object files and providing those wildcard object files to the user's mobile phone or other mobile device is described below, however, it should be understood that a variety of techniques can be used for this purpose, and that the Portable Card Generator is not intended to be limited by the following example.

In particular, one exemplary process for generating wildcard object files and providing those wildcard object files to the user involves the following steps:
a. For every registered CC, the SP creates a wildcard object file, containing the CC content or account information encrypted with key Kₑ. This encrypted wildcard object file is then sent or provided by the SP to Alice's phone. The wildcard object file is then stored locally in the phone thereafter.
b. To use a particular card, Alice simply selects the corresponding account information for that card from the phone's UI (e.g., an icon and/or text identifier for the card). The corresponding wildcard object file from the phone is then sent to the writing module to recreate the magnetic card content on the wildcard. However, since the contents of the wildcard object file are encrypted, the writing module first uses the corresponding decryption key to decrypt the data in the wildcard object file before writing that data to the magnetic stripe of the wildcard. Note that with conventional card-based infrastructures, data written on magnetic stripes of credit cards and the like is not encrypted.
c. Finally, once the decrypted account information has been written to the wildcard, the newly programmed wildcard is then ready for use in the same manner as if it were the original card provided by the card issuer.

### 2.5 Exemplary Security Issues and Solutions

The following paragraphs generally describe a variety of security issues that may arise in view of potential unauthorized attempts to use a lost or stolen phone, wildcard, or the account information stored as wildcard object files on the user's phone. However, it should be noted that the exemplary security scenarios discussed below are not intended to limit the Portable Card Generator to the security scenarios described, and that as many or as few security techniques as desired can be adapted for use by the Portable Card Generator.

### 2.5.1 Scenario 1—Lost or Stolen Phone and Wildcard

In this first example, assume that Alice has lost her phone and the associated wildcard, and that the phone and wildcard have been recovered by a bad actor who desires to use the account information stored in the phone in the form of wildcard object files and/or the wildcard itself. For purposes of discussion, this bad actor will be referred to as “Mallory”.

In this example, as soon as Alice realizes the phone and wildcard are lost or stolen, she can simply log into her SP account and cancel all of the registered cards in the SP account. As noted above, as soon as Alice cancels any of her registered cards, the SP will immediately report this cancellation to the card issuer. Cancelled, deactivated or unregistered cards will then be rejected by the bank or credit issuers from then on. Consequently, even if Mallory uses the phone (assuming that Mallory has somehow bypassed the key lock, if used), any wildcards created using the wildcard object files stored in the phone will be rejected when Mallory attempts to use those cards.

Note that is rejection is the same as if a user reports her credit card as being lost or stolen to the card issuer. In particular, any subsequent attempted transactions using that card will then be automatically rejected by the existing card-based infrastructure. Further, it should also be noted that in this scenario (e.g., phone and wildcard obtained by Mallory), Mallory will not be able to use the phone to create new wildcards since Mallory will, presumably, not have access to the login information for Alice's SP account and thus will not be able to register any new cards to Alice's SP account using Alice's phone. Consequently, as discussed above, the SP will not generate any new encrypted wildcard object files for transmission to Alice's phone.

### 2.5.2 Scenario 2—Lost Original Card

In this second example, assume that Alice has lost a real credit card or other card corresponding to one of the wildcard object files. In this case, she can simply log into her SP account and cancel the corresponding registered cards in the SP account. As noted above, as soon as Alice cancels any of her registered cards, the SP will immediately report this cancellation to the card issuer. Cancelled, deactivated or unregistered cards will then be rejected by the bank or credit issuers from then on. Further, for security purposes, it would be prudent for Alice to directly contact the card issuer to directly cancel the lost or stolen original card.

### 2.5.3 Scenario 3—Lost Wildcard

In this third example, assume that Alice has lost a wildcard after its content is written (i.e., a programmed wildcard). In this case, if Alice is unsure of what account information was on the wildcard, she can simply retrieve the card account information regarding which wildcard object file was last written to the wildcard from the phone's UI. Alice then simply contacts the card issuer or logs into her SP account to cancel the corresponding card as it as if she has lost the real credit card.

### 2.5.4 Scenario 4—Lost Phone

In this fourth example, assume that Alice has lost has lost her phone. In this case, Alice can access her phone service provider to remove all contents on her phone remotely. Note that this is a conventional service provided by some phone carriers. In addition, for additional security, Alice can optionally contact the card issuer or log into her SP account to cancel all cards having wildcard object files on the phone.

### 2.5.5 Scenario 5—Attempted Use of Lost Wildcard

In this fifth example, assume that Mallory tries to program Alice's lost wildcard using Mallory's phone. Mallory cannot program Alice's lost wildcard since it is not registered or authorized for use with Mallory's phone. Further, Mallory cannot register others' cards with her own SP account since the credit organization (i.e., the card issuer) will not have corresponding information for verification (as discussed above).

### 2.5.6 Scenario 6—Attempted Registration of Third Party Card

In this sixth example, assume that Mallory tries to tries to register Bob's credit card and then to have the SP generate a wildcard object file for subsequent programming of a wildcard using the account information for Bob's credit card. Whether or not Bob has registered his phone or credit card with the SP, Mallory will not be able to link Bob's credit card with her own FA (see Section 2.4.3 for a discussion of card registration) since verification will fail. Consequently, Mallory will not be able to register third party cards for wildcard object file generation by the SP.

### 2.5.7 Scenario 7—“Jailbroken” Phone

In this seventh example, assume that Mallory jailbreaks or hacks her phone and runs her own software in an attempt to create wildcards from stolen credit cards. Since Mallory does not know the encryption key, Kₑ, corresponding to the decryption key, K_{d}, associated with the writing module, Mallory cannot create a valid wildcard object file that the writer can write correctly to the wildcard, even if that wildcard is registered or authorized for use with that phone.

### 2.6 Single-Use Card Numbers

An example of the use of well-known single-use or one-time use card numbers includes the “ShopSafe®” program. In general, ShopSafe® is a credit card fraud protection service that allows the user to create a temporary card number each time the user wants to make an online purchase. This temporary number links directly to the user's real credit card account number but keeps that real card number completely private and protected. The ShopSafe® number is used just like any other credit card, such that the merchant or vender never knows that it's not the real credit card. These temporary numbers can also be issued with particular dollar amount limits requested by the user. In general, these temporary or one-time use numbers are securely generated for the user, whenever requested by the user. Following use, or following some predetermined time period, the temporary number simply expires and cannot be used or reused. As such, attempted fraud using such numbers is prevented.

In the context of the Portable Card Generator, the user simply registers the temporary or one-time use card number with her SP account, with the SP then sending a corresponding wildcard object file to the user's phone, for use as discussed above in programming the wildcard for use with the corresponding account information.

One-time card numbers improves security to the two scenarios discussed above in Sections 2.5.1 and 2.5.2. In particular, in the event that Mallory has somehow acquired Alice's lost or stolen phone, Alice can simply log into her SP account and cancel all of the one-time use cards in the SP account. As noted above, as soon as Alice cancels any of her registered cards, the SP will immediately report this cancellation to the card issuer (in the case that the card issuer has generated the one time use card numbers). Cancelled, deactivated or unregistered cards will then be rejected by the bank or credit issuers from then on during any attempted use of those numbers. Further, even without reporting the loss of those numbers, the temporary numbers will expire after a relatively short time period (typically on the order of hours or days). In the case that the SP has generated the card numbers on behalf of the card issuer (see Section 2.6.1), the SP will simply cancel those card numbers directly, thus eliminating any possibility that card transactions will be automatically approved during an attempted use of a wildcard programmed with any such number.

In the case that Mallory has somehow acquired Alice's lost or stolen wildcard programmed with a one-time use number, Alice simply logs in to her SP account or otherwise contacts the SP to invalidate that number. Again, even if she forgets to do this, the one-time use number will expire after a relatively short time period.

### 2.6.1 Support for One-Time Use Cards if not Offered by Card Issuer

If a card provider or issuer offers one-time card number service, then Alice can request a one-time card whenever she wants to use her card, as discussed above (e.g., ShopSafe®). That way, the real card number is never exposed via use of the wildcard.

However, if a card provider or issuer does not offer a one-time card service, but is willing to contact the SP during transaction processing, then it can use a one-time card service provided by the SP, as discussed below.
1. To create a one-time card, Alice asks the SP to create a temporary number for her actual credit card number. The SP then creates a mapping between the temporary number and the actual number, and sends Alice a wildcard object file containing the temporary number, instead of the actual number. (Alice can download multiple wildcard object files with different temporary numbers at a time.)
2. While processing a wildcard containing a temporary credit card number, the card issuer (e.g., VISA, MasterCard, etc.) first contacts the SP to retrieve the corresponding actual credit card number. The card issuer then simply uses the actual credit card number in subsequent processing.

### 2.7 Additional Embodiments and Considerations

A variety of additional embodiments and enhancements may be adapted for use with the Portable Card Generator, as summarized below.

For example, as is well known, debit-type “gift cards” or gift certificates in a credit card type format are widely available for use within the existing card-based infrastructure. Consequently, one advantageous use of the Portable Card Generator is that a “gift card” can be email or otherwise provided to the user's phone in the form of a corresponding wildcard object file. Such gift card wildcard object files can be purchased from the SP (or any other gift card seller) and then provided to any designated user via the SP. When a user then wants to use that gift card, she simply selects the associated wildcard object file and programs her wildcard, as discussed above.

Similarly, coupons can be emailed to the user's mobile phone in the form of a wildcard object file. In this case, the corresponding wildcard object file can be used to either write the corresponding information to the wildcard, or can be used to generate an image (e.g., barcodes or any other image-based encoding such as QR-codes, for example) on the display of the mobile phone. That display can then be scanned as if the user were presenting a paper coupon or the like to the merchant or vender.

Another advantage of the use of wildcard object files is that in the event that the user loses a credit card or some other card, delivery of a new or replacement card can be accomplished within minutes via the SP by simply emailing or otherwise transmitting a new wildcard object file having a new or replacement card number to the user's device.

Further, since many mobile phones are WiFi enabled, or have a variety of other communications mechanisms (e.g., WiFi, Bluetooth®, email, etc.), various offers, gift cards, coupons, etc., can be delivered to user based on the user's location (e.g., transmit a coupon for free ice cream samples to the user's phone when she is walking past an ice cream parlor) or predefined preferences (such as subscribing to a coupon service).

Another advantageous use of the Portable Card Generator involves the use of electronic hotel room keys. In general, many hotels use electronic locks having room “keys” that are credit card size objects having a magnetic stripe. Consequently, the “account information” corresponding to the information on the magnetic stripe for such room keys can be emailed or otherwise uploaded to the user's phone as a wildcard object file. The user can then use her wildcard to create a room key whenever necessary.

### 2.8 Vendor Verifiable Security Components

In addition to the secure techniques described above that prevent unauthorized generation and use of cards using the Portable Card Generator writing module, in some embodiments the wildcard writing module itself can provide security features that help limit its unauthorized use by users other than the rightful owner of the wildcard and also make it compatible with the existing security processes in widespread card acceptance infrastructures. For this purpose, the wildcard uses some of its front and back surfaces or display screen to have a permanent or displayable on-demand impression of a user's likeness, such as an image of user's face, user's signature, or user's fingerprint. The user's name embossed or displayed on the wildcard can also be compared to other identification (especially trusted party issued identification such as a driver's license or passport). The vendor accepting the card can use their existing infrastructure to verify user identity when accepting a wildcard similar to how they verify identity for traditional cards.

### 3.0 Exemplary Operating Environments

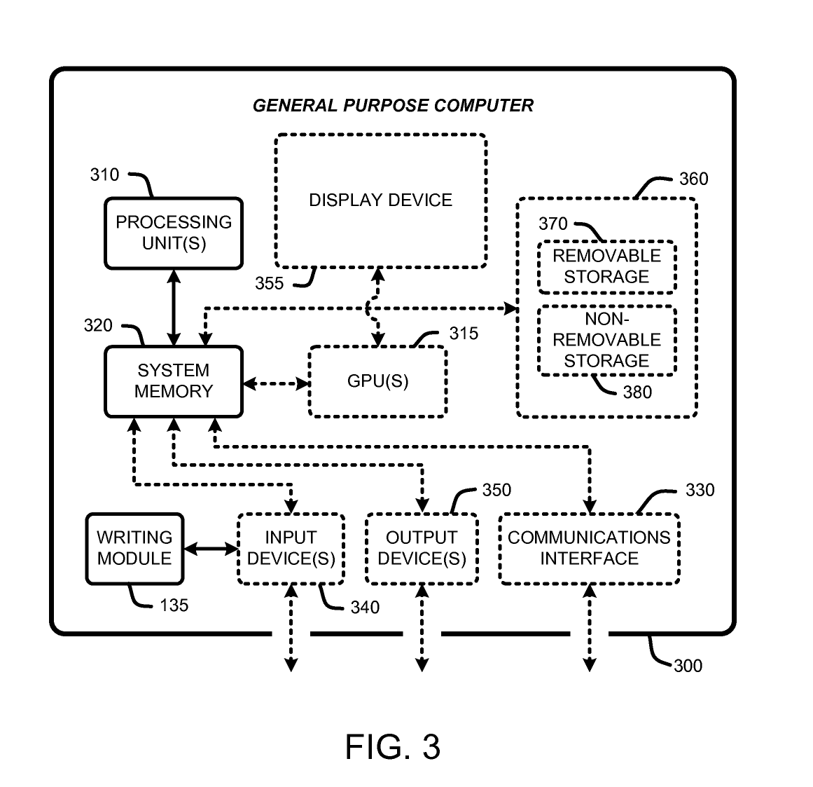

The Portable Card Generator described herein is operational within numerous types of general purpose or special purpose computing system environments or configurations. FIG. 3 illustrates a simplified example of a general-purpose computer system on which various embodiments and elements of the Portable Card Generator, as described herein, may be implemented. It should be noted that any boxes that are represented by broken or dashed lines in FIG. 3 represent alternate embodiments of the simplified computing device, and that any or all of these alternate embodiments, as described below, may be used in combination with other alternate embodiments that are described throughout this document.

For example, FIG. 3 shows a general system diagram showing a simplified computing device 300 having an integral or attached writing module 135. Such computing devices include, but are not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the Portable Card Generator, the device should have a sufficient computational capability and system memory to enable basic computational operations as well as an integral or attached writing module 135 for writing wildcards, as discussed above. In particular, as illustrated by FIG. 3, the computational capability is generally illustrated by one or more processing unit(s) 310, and may also include one or more GPUs 315, either or both in communication with system memory 320. Note that that the processing unit(s) 310 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 3 may also include other components, such as, for example, a communications interface 330. The simplified computing device of FIG. 3 may also include one or more conventional computer input devices 340 (e.g., pointing devices, keyboards, audio input devices, video input devices, haptic input devices, devices for receiving wired or wireless data transmissions, etc.). The simplified computing device of FIG. 3 may also include other optional components, such as, for example, one or more conventional computer output devices 350 (e.g., display device(s) 355, audio output devices, video output devices, devices for transmitting wired or wireless data transmissions, etc.). Note that typical communications interfaces 330, input devices 340, output devices 350, and storage devices 360 for general-purpose computers are well known to those skilled in the art, and will not be described in detail herein.

The simplified computing device of FIG. 3 may also include a variety of computer readable media. Computer readable media can be any available media that can be accessed by computer 300 via storage devices 360 and includes both volatile and nonvolatile media that is either removable 370 and/or non-removable 380, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the Portable Card Generator described herein, or portions thereof, may be stored, received, transmitted, or read from any desired combination of computer or machine readable media or storage devices and communication media in the form of computer executable instructions or other data structures.

Finally, various elements of the Portable Card Generator described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

The foregoing description of the Portable Card Generator has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Portable Card Generator. It is intended that the scope of the invention be limited not by this detailed description, but rather by the claims appended hereto.

What is claimed is:

1. A system for writing card account data to a rewritable card, comprising:
a portable computing device having a writing module capable of writing card account data to a rewritable card;
wherein the portable computing device receives a plurality of “wildcard object files”, each wildcard object file including encrypted card account data for a particular user card account;
displaying a user interface on a display of the portable computing device for allowing the user to select any of the wildcard object files;
following selection of one of the wildcard object files by the user:
interfacing the rewritable card with the writing module,
using the writing module to decrypt the encrypted card account data of the selected wildcard object file using a private decryption key associated with the writing module, and
writing the decrypted card account data to the rewritable card to create a programmed “wildcard” that is useable within existing card-based infrastructures as a surrogate for the card account corresponding to the selected wildcard object file.

2. The system of claim 1 further comprising a service provider for setting up a secure user account, and wherein setting up a secure user account comprises:
registering the portable computing device with the service provider via the secure user account and providing the decryption key associated with the writing module to the service provider;
verifying that the user is an authorized user of the portable computing device;
if the user is verified to be an authorized user of the portable computing device, registering a plurality of user card accounts with the secure user account;
verifying that the user is an authorized user of each registered card account; and
for each registered card account for which the user is an authorized user, using the service provider to generate a corresponding wildcard object file by encrypting corresponding card account data using a private encryption key corresponding to the private decryption key.

3. The system of claim 2 wherein the plurality of encrypted wildcard object files received by the portable computing device are transmitted to the portable computing device by the service provider from the encrypted wildcard object files generated for the registered card accounts in the secure user account.

4. The system of claim 1 wherein the rewritable card includes identifying information that prevents unauthorized writing modules from writing card account data to the rewritable card.

5. The system of claim 1 wherein the rewritable card includes a magnetic stripe for storing the card account information written to the rewritable card by the writing module.

6. The system of claim 1 wherein the rewritable card includes an RFID tag for storing the card account information written to the rewritable card by the writing module.

7. The system of claim 1 wherein the rewritable card includes smartcard circuitry for storing the card account information written to the rewritable card by the writing module.

8. The system of claim 1 wherein the rewritable card includes two or more of a magnetic stripe, an RFID tag, and smartcard circuitry for storing the card account information written to the rewritable card by the writing module.

9. The system of claim 1 wherein the card account information for one or more of the registered card accounts includes a one-time card number provided to the service provider by a card issuer for the card account.

10. The system of claim 1 wherein the card account information for one or more of the registered card accounts includes a one-time card number provided by the service provider on behalf of a card issuer for the card account.

11. A method for writing card account data to a rewritable card, comprising steps for:
setting up a secure user account for a user with a trusted service provider;
registering a particular computing device and an associated writing module with a private decryption key in the secure user account, and wherein the service provider verifies that the user is an authorized user of the particular computing device;
registering a plurality of card accounts in the secure user account, and wherein the service provider verifies that the user is an authorized user of each registered card account;
wherein the service provider generates a “wildcard object file” for each registered card account for which the user is an authorized user, each wildcard object file including encrypted card account data corresponding to a different one of the user card accounts, and wherein an encryption key used to generate the encrypted card account data is generated from the decryption key of the writing module;
transmitting each wildcard object file from the service provider to the registered computing device;
selecting one of the wildcard object files via a user interface displayed on a display device of the computing device;
interfacing a rewritable card with the writing module;
using the writing module to decrypt the encrypted card account data of the selected wildcard object file using the private decryption key; and
writing the decrypted card account data to the rewritable card to create a programmed “wildcard” that is useable within existing card-based infrastructures as a surrogate for the card account corresponding to the selected wildcard object file.

12. The method of claim 11 wherein the rewritable card includes identifying information that prevents unauthorized writing modules from writing card account data to the rewritable card.

13. The method of claim 11 wherein the rewritable card includes one or more of a magnetic stripe, an RFID tag, and smartcard circuitry for storing the card account information written to the rewritable card by the writing module.

14. The method of claim 11 wherein the card account information for one or more of the registered card accounts includes a one-time card number provided to the service provider by a card issuer for the card account.

15. A computing device for programming rewritable cards for use with secure-card-based transactions, comprising:
a computing device having an associated writing module with a private decryption key;
wherein the computing device and private decryption key are registered for a specific user with a remote service provider, said service provider verifying whether the specific user is an authorized user of the computing device;
for a verified user of the registered computing device, registering a plurality of card accounts with the service provider, said service provider verifying whether the specific user is an authorized user of each card account;
for each card account where the specific user is an authorized user of both the computing device and the card account, causing the service provider to generate an encrypted “wildcard object file”, each wildcard object file including encrypted card account data corresponding to a different one of the user card accounts, and wherein an encryption key used to generate the encrypted card account data is generated from the decryption key of the writing module;
causing the service provider to transmit each wildcard object file to the registered computing device;
selecting one of the wildcard object files via a user interface displayed on a display device of the registered computing device;
interfacing a rewritable card with the writing module;
using the writing module to decrypt the encrypted card account data of the selected wildcard object file using the private decryption key; and
writing the decrypted card account data to the rewritable card to create a programmed “wildcard” that is useable within existing card-based infrastructures as a surrogate for the card account corresponding to the selected wildcard object file.

16. The computing device of claim 15 wherein the rewritable card includes identifying information that prevents unauthorized writing modules from writing card account data to the rewritable card.

17. The computing device of claim 15 wherein the rewritable card includes one or more of a magnetic stripe, an RFID tag, and smartcard circuitry for storing the card account information written to the rewritable card by the writing module.

18. The computing device of claim 15 wherein the card account information for one or more of the registered card accounts includes a one-time card number provided to the service provider by a card issuer for the card account.

19. The mobile computing device of claim 15 further comprising means for directing the service provider to initiate cancellation of all user card accounts transmitted to the computing device as encrypted wildcard object files.

20. The computing device of claim 15 wherein the card account information for one or more of the user card accounts includes a one-time card number provided by the service provider on behalf of a card issuer for the card account.
